(19) United States
(12) Patent Application Publication
(10) Pub. No.: US 2020/0265519 A1
(43) Pub. Date: Aug. 20, 2020

(54) METHOD AND SYSTEM FOR CREATING A SECURITIES LENDING RATE VOLATILITY INDICATOR

(71) Applicant: Syva Capital, LLC, Essex, VT (US)

(72) Inventor: Christopher Sappo, Essex, VT (US)

(21) Appl. No.: 16/646,782

(22) PCT Filed: Oct. 24, 2018
(86) PCT No.: PCT/US18/57225

§ 371 Date: Mar. 12, 2020

Related U.S. Application Data
(60) Provisional application No. 62/576,305, filed on Oct. 24, 2017.

(51) Int. Cl. G06Q 40/06

(52) U.S. Cl. CPC G06Q 40/06

(57) ABSTRACT

A method and system for creating a securities lending rate volatility indicator is provided that includes obtaining securities lending transactional data for a plurality of securities lending transactions for a given period of time and determining a measure of volatility in the rebate rate associated with those transactions. The determination of rebate rate volatility includes using volume weighted lending and borrowing rebate rates for the securities transactions based in part on the type of collateral involved in the transactions, the rebate rate, the benchmark interest rate, and the expiration dates of the transactions.

### FIELD OF THE INVENTION

The present invention generally relates to financial trading systems. In particular, the present invention is directed toward a system and method for deriving a securities lending rate volatility indicator.

### BACKGROUND

The securities lending environment acts as a wholesale marketplace for participants to lend or borrow securities, thereby providing liquidity to financial markets. Securities lending is a contractual financial agreement between two counterparties, a lender and a borrower, to transfer securities in exchange for collateral on a temporary basis until the original securities are returned. The borrower pays a borrowing fee to the lender for the use of the loaned securities.

The collateral in securities lending can either be other securities or cash. If the borrower gives the lender cash as collateral, the lender is obligated to reinvest the cash for the benefit of the borrower. Any return on this reinvestment would go to the borrower except that often the counterparties agree that only an agreed proportion (generally referred to as the rebate rate) of the reinvestment return will go back to the borrower. The lender usually deducts the borrowing fee from the reinvestment return that is given to the borrower. Therefore, rather than paying a borrowing fee separately, the borrowing fee is implicit in the rebate rate. As such, the price negotiated between a borrower and a lender for borrowing securities is essentially the rebate rate.

At a high level, then, the cost to borrow a security is the rebate rate. The rebate rate is generally commensurate with the Federal Funds Rate, but if, for example, a security is in high demand, the rebate rate may increase. And the more demand there is, the higher the rebate rate, or, in essence, the price, for borrowing that security becomes.

When securities lending traders generally believe in the direction of the securities they're trading, counterparties will have similar valuations regarding the amount of the borrowing fee. When markets get turbulent, however, uncertainty arises regarding the amount of the borrowing fee and a larger spread, or deviation, in borrowing fees may develop, resulting in an increase in the volatility of the rebate rate over a given period of time and/or for a security or group of securities.

Volatility in this context, then, is a measurement for the variation of securities lending rates between counterparties. This information reflects the varying rates the open market transacts business in. A measurement of volatility for a security, or a composite index, can assist financial market participants in two primary ways. First, a measurement of the volatility of rebate rates will expose inherent volatility of securities or indices in a given moment of time. Second, traders can adjust the timing of buying and selling in light of the level of volatility indicated.

Current securities lending data analytics providers will give day-to-day rebate rates for a security, including minimum, maximum, and average rebate rates on an intra-day, a daily, or a historical basis. What is needed is an indicator of the volatility or variance of rebate rates on a per security or on a per composite index basis as well as on an intra-day, a daily, and an historical basis.

### SUMMARY OF THE DISCLOSURE

In an exemplary embodiment, a system for generating and disseminating a measure of volatility for rebate rates in securities lending is provided that includes a computer system that has a data storage module for receiving securities lending transactional data for transactions involving a selection of securities occurring within a selected time period, the transactional data including, for each transaction, whether cash or non-cash collateral was used, a date of transaction, an expiration date of an agreement covering each of the transactions, a benchmark interest rate as of the date, a rebate rate, and a quantity of securities transacted. The system also has a processor configured to determine a measure of volatility of rebate rates for the selected securities for the selected time period by using a conditional, weighted calculation of variation, and a communications module, the communications module disseminating the measure of volatility to requesting users.

Additionally or alternatively, the measure of volatility is annualized.

Additionally or alternatively, the measure of volatility is annualized by multiplying by the square root of the number of time periods in a year for the selected time period.

In another embodiment, a method for determining a measure of securities lending rate volatility is provided that includes selecting a set of securities for which to determine the measure of securities lending rate volatility, selecting a time period over which to determine the measure of securities lending rate volatility for the selected set of securities, determining an intrinsic rebate rate for each of at least a plurality of open securities transactions occurring in the time period involving the selected set of securities, determining a date of occurrence for each of the plurality of open securities transactions, determining a time of occurrence for each of the plurality of open securities transactions, determining a date of expiration for each of the plurality of open securities transactions, determining a quantity of shares involved for each of the plurality of open securities transactions, determining a sum of the quantity of shares involved for the plurality of open securities transactions, determining a collateral type for each of the plurality of open securities transactions, determining a benchmark interest rate in place at the time of occurrence for each of the plurality of open securities transactions, and determining the measure of securities lending rate volatility for the time period for the selected set of securities based on at least the intrinsic rebate rate for each of the plurality of open securities transactions occurring in the time period involving the selected set of securities, the date of occurrence for each of the plurality of open securities transactions, the date of expiration of each of the plurality of open securities transactions, the quantity of shares involved in each of the plurality of open securities transactions, the sum of the quantity of shares involved for each of the plurality of open securities transactions, the collateral type for each of the plurality of open securities transactions, and the benchmark interest rate in place at the time of occurrence for each of the plurality of open securities transactions.

Additionally or alternatively, the step of determining the measure of securities lending rate volatility is repeated based on updated data within five minutes.

In another embodiment, a method for creating a securities lending rate volatility indicator is provided that includes selecting a time period, selecting at least one security, receiving, for each of a plurality of securities lending transactions determined to have occurred in the selected time period and involving the selected security, a rebate rate, a date of transaction, an expiration date, and a quantity of shares involved, and determining a measure of volatility, V, for the rebate rates for the plurality of securities lending transactions for the time period by applying a formula of

$$V = \sqrt{\vert ( {Σ}_{i = 1}^{n} ( \frac{( {X}_{i}^{2} ) * {W}_{i}}{{Z}_{1}} ) ) - {( {Σ}_{i = 1}^{n} ( \frac{( {X}_{i} ) * {W}_{i}}{{Z}_{1}} ) )}^{2} \vert}$$

where n is a quantity of transactions determined to have occurred in the selected time period,
where Z₁ is a sum of the quantity of shares involved in the plurality of securities lending transactions, and where X and W depend on a set of conditions, the set of conditions including:

((O=C)∧(∃R)∧((E≥D)∨( [symbol] E))∧(∃B)→X=(B−R)

((O=C)∧(∃R)∧((E≥D)∨( [symbol] E))∧(∃B)→W=(Q)

((O=L)∧(∃R)∧((E≥D)∨( [symbol] E))→X=(R)

((O=L)∧(∃R)∧((E≥D)∨( [symbol] E))→W=(Q)
where:
O is a collateral type variable, the collateral type being for a one of the plurality of securities lending transactions,
C is the collateral type for a cash collateral transaction,
L is the collateral type for a non-cash collateral transaction,
E is the expiration for the one of the plurality of securities lending transactions,
D is a date of transaction for the one of the plurality of securities lending transactions,
B is a benchmark interest rate in place when the one of the plurality of securities lending transactions occurred, and
R is the rebate rate for the one of the plurality of securities lending transactions.

Additionally or alternatively, the method includes annualizing the measure of volatility by multiplying by the square root of the number of time periods in a year for the time period.

In another embodiment, a system for determining a measure of volatility for rebate rates in securities lending is provided that includes a computer system having a data storage module for receiving securities lending transactional data for a plurality of transactions involving a selection of securities occurring within a selected time period, the transactional data including, for each transaction, whether cash or non-cash collateral was used, a date of transaction, an expiration date of an agreement covering each of the transactions, a benchmark interest rate as of the date, a rebate rate, and a quantity of securities transacted. The computer system further includes a processor configured to determine a measure of volatility of rebate rates for the selected securities for the selected time period by: determining an intrinsic rebate rate for each of the plurality of transactions; determining a date of occurrence for each of the plurality of transactions; determining a time of occurrence for each of the plurality of transactions; determining a date of expiration for each of the plurality of transactions; determining a quantity of shares involved for each of the plurality of transactions; determining a sum of the quantity of shares involved for the plurality of transactions; determining a collateral type for each of the plurality of transactions; determining a benchmark interest rate in place at the time of occurrence for each of the plurality of transactions; and determining the measure of securities lending rate volatility for the time period for the selected set of securities based on at least the intrinsic rebate rate for each of the plurality of transactions occurring in the time period, the date of occurrence for each of the plurality of transactions, the date of expiration of each of the plurality of transactions, the quantity of shares involved in each of the plurality of transactions, the sum of the quantity of shares involved for each of the plurality of transactions, the collateral type for each of the plurality of transactions, and the benchmark interest rate in place at the time of occurrence for each of the plurality of transactions.

Additionally or alternatively, the processor is further configured to annualize the measure of volatility.

Additionally or alternatively, the measure of volatility is determined and disseminated in less than five minutes.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of an embodiment of a system and method for creating a securities lending rate volatility indicator of the present invention;

FIG. 2 is a block diagram for another aspect of the system and method for creating a securities lending rate volatility indicator of the present invention; and

FIG. 3 is a table of sample transaction data used to calculate a measure of securities lending volatility in accordance with an embodiment of the present invention.

### DESCRIPTION OF THE DISCLOSURE

A securities lending derived volatility indicator of the present invention estimates the spread or degree of the unknown or uncertainty within the securities lending markets by continually assessing the volatility in rebate rates based on transaction data including whether cash or non-cash collateral was used, the date of the transaction, the date the agreement covering the transaction is set to expire, the benchmark interest rate at the time of the transaction, and the rebate rate for the transaction. In addition, accuracy is improved by using a weighted average calculation for the rebate rates so that trades involving higher volume are given greater emphasis.

In this way, volume weighted variation of lending/borrowing rebate rates of a security are tracked. This information can be aggregated for all securities within a composite index or other grouping or selection of securities. The volatility in an individual security, composite index, or grouping of securities, can thereby be quantified, and annualized if desired to allow for a baseline comparison. This measure of securities lending volatility provides greater market transparency and enhanced decision-making throughout the financial industry. By having access to this measure of volatility, securities lending market participants are able to more easily notice when market activity changes direction with respect to securities lending rates. This can assist both lenders and borrowers on assessing their respective position within the lending markets. For example, the present invention allows a lending agent to be immediately notified about discrepancy of rebate rates, therefore suggesting the lending agent re-rate loans in order to garner additional revenue. In addition, for borrowers such as prime brokers who are borrowing securities to facilitate the borrowing needs of their own clients, prime brokers can continually assess their holdings and attempt to lock in lower rates with lenders before or at the time volatile activity rises. Lastly, stock market participants are also thus able to assess securities lending rebate rate volatility to provide advanced warning indication of impending activity in equity markets. In an individual security, composite index, or grouping of securities, spikes in securities lending rebate rate volatility can be directly correlated to negative stock price movements. Furthermore, since securities lending rate volatility data can be recalculated and disseminated every minute or less, the measure of volatility can be re-determined at a similar frequency, and this updated measure can provide essentially a real time indication of stock market price fluctuations.

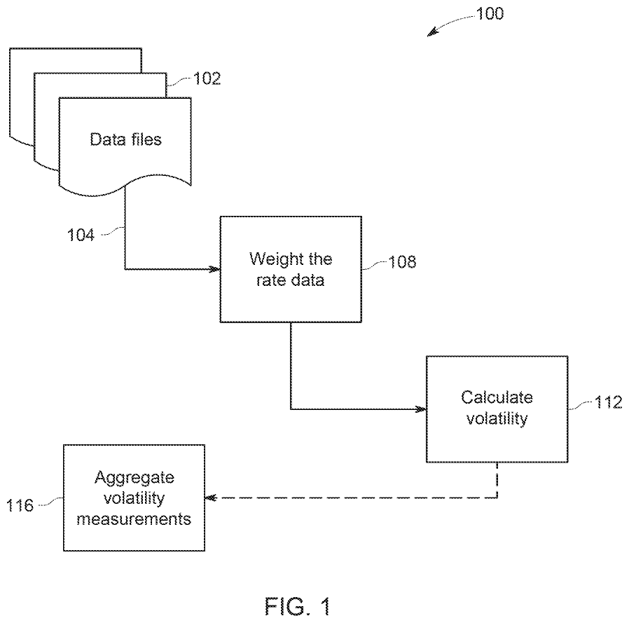

At a high level, and with reference to FIG. 1, a process 100 for creating a securities lending rate volatility indicator requires obtaining securities lending loan/borrow transactional data 102 at step 104 for a time period, such as a day, a month, a quarter, or a year. A conditional value weighted rate dispersion calculation is applied to transaction data 102 in block 108 in order to give more weight to higher volume transactions. At block 112, the weighted rates from transactional data 102 are processed in order to determine a measure of volatility over time for a given security (more details on these techniques are given below). Then, optionally, the measures of volatility for securities can be aggregated at block 116 to give a measure of overall volatility for a given index or other grouping. Further, the measure of volatility may be annualized (or normalized to any other time frame of interest).

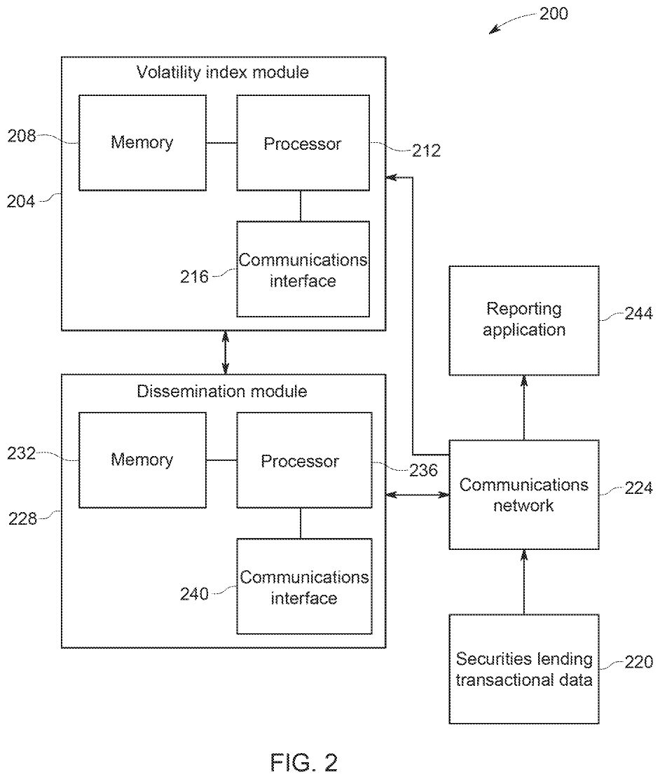

Turning to FIG. 2, an overview is provided for a system 200 for obtaining, processing, and disseminating information related to securities lending rebate rate volatility according to the present invention. A volatility index module 204 includes a memory 208, a processor 212, and a communications interface 216. Volatility index module 204 receives securities lending transactional data 220 at communications interface 216 via a communications network 224. Securities lending transactional data 220 can then be used by processor 212 to calculate a measure of volatility in rebate rates via process 100 discussed above, for example. The measure of volatility, for a security and/or any aggregation of securities, can be sent, in an initial form or an annualized form, on an intra-daily, a daily, and/or n historical basis, to dissemination module 228, which includes a memory 232, a processor 236, and a communications interface 240. In dissemination module 228, the measures of volatility may be processed for reporting at processor 236 and sent by communications interface 240 to a reporting application 244 via communications network 224.

In a preferred embodiment, an indication or measure of volatility is determined based on lending and borrowing rebate rates for all (or some subset of) open securities transactions, for a given time period in the securities lending market. The data set may include all relevant transactions occurring within a given time period, such as one day, a month, a quarter, six months, or a year. An intrinsic rebate rate is determined individually for all relevant open securities lending transactions. For each such transaction, the intrinsic rebate rate, or the difference between the benchmark interest rate and the rebate rate, depending on certain parameters pertaining to the transaction, is squared and then multiplied by the quantity of shares involved in that transaction. This product is divided by the sum of the quantities of securities involved in all the relevant transactions occurring in the given time period to effectively provide a weighted average. This process is repeated for each relevant transaction in the period and all those quotients are summed. From the resulting sum is subtracted the square of the sum over all relevant transactions in the period of the quotient produced by multiplying, for each relevant transaction in the period, the intrinsic rebate rate, or the difference between the benchmark interest rate and the rebate rate, depending on certain parameters pertaining to the transaction, by the quantity shares involved in that transaction. This product is divided by the sum of the quantities of securities involved in all the relevant transactions occurring in the given time period to effectively provide a weighted average. The absolute value is taken of the difference between the latter sum and the square of the former sum, and the square root is taken of this value, resulting in the measure of volatility of the rebate rate.

The above determination of an indication of volatility can be expressed as a formula such as shown below in Equation 1:

$$V = \sqrt{\vert ( {Σ}_{i = 1}^{n} ( \frac{( {X}_{i}^{2} ) * {W}_{i}}{{Z}_{1}} ) ) - {( {Σ}_{i = 1}^{n} ( \frac{( {X}_{i} ) * {W}_{i}}{{Z}_{1}} ) )}^{2} \vert} \qquad Eq . 1$$

where
V=volatility indicator,
n=the number of transactions within a specified timeframe, and

Z₁=Σᵢ₌₁ⁿ(Qᵢ) Eq. 2

where Q=the quantity of securities transacted for each transaction (Qᵢ) that occurred within the specified timeframe, and where X and W are as follows depending on the below conditions:

((O=C)∧(∃R)∧((E≥D)∨( [symbol] E))∧(∃B)→X=(B−R) Eq. 3

((O=C)∧(∃R)∧((E≥D)∨( [symbol] E))∧(∃B)→W=(Q) Eq. 4

((O=L)∧(∃R)∧((E≥D)∨( [symbol] E))→X=(R) Eq. 5

((O=L)∧(∃R)∧((E≥D)∨( [symbol] E))→W=(Q) Eq. 6

where
O=collateral type for a transaction,
C=cash collateral was used in the transaction,
L=non-cash collateral was used in the transaction,
E=date the agreement covering the transaction is set to expire,
D=the date of the transaction,
B=benchmark interest rate at the time of the transaction, and
R=rebate rate for the transaction.

In operation, a security or group of securities for which volatility data is sought is selected, and a particular timeframe of interest is selected. Then all open loan/borrow securities lending transactional data is obtained for transactions involving the selected security or group of securities that occurred within the timeframe of interest. The transactional data for each such transaction may include whether cash or non-cash collateral was used, the date of the transaction, the date the agreement covering the transaction is set to expire, the benchmark interest rate at the time of the transaction, the rebate rate for the transaction, and the quantity of securities transacted in the transaction.

Based on this data for each of the transactions meeting the selection criteria (timeframe, identity of the security), a volatility indicator is determined using Equation 1 above (along with Equation 2) with the conditional definitions provided in Equations 3-6. If, for example, the collateral used for a transaction is cash, a rebate rate exists for the transaction, a respective benchmark rate exists, and the loan expiration date for that transaction does not have a value or is greater than or equal to the transaction date, then the value of X in Equation 1 becomes the difference between the benchmark rate and the rebate rate. However, if the collateral used for a transaction is non-cash, a rebate rate value exists for the transaction, and loan expiration date for that transaction does not have a value or is greater than or equal to the transaction date, then the value of X in Equation 1 becomes the rebate rate. Similarly, with respect to the value of W in Equation 1, if the collateral used for a transaction is cash, a rebate rate exists for the transaction, a respective benchmark rate exists, and the loan expiration date for that transaction does not have a value or is greater than or equal to the transaction date, then the value of W in Equation 1 is the quantity of securities transacted in that transaction. And if the collateral used for a transaction is non-cash, a rebate rate value exists for the transaction, and loan expiration date for that transaction does not have a value or is greater than or equal to the transaction date, then the value of W in Equation 1 is the quantity of securities transacted in that transaction. These conditional determinations are made for each transaction that meets the criteria.

In addition, the value of Z₁ is determined by summing, per Equation 2, all of the quantities (Q) for all of the transactions, from i=1 to i=n, the number of transactions that meet the selection criteria. Equation 1 can then be used with Z₁, the appropriate X for each transaction, and the appropriate W for each transaction, to calculate an indication of volatility. In Equation 1, the square root of the absolute value of the difference between sums is taken in which the sums are taken from i=1 to i=n and in which, for each value of i, the conditions given in Equations 3-6 determine the values of Xᵢ and Wᵢ, which may vary from transaction to transaction.

Optionally, the resulting indication of volatility, V, can be annualized by multiplying V by a factor related to the timeframe for which V was determined. For example, an indication of volatility determined based on transactions occurring over a day can be multiplied by the square root of the approximate number of business or trading days in a year (e.g., 260), an indication of volatility determined based on transactions occurring over a week can be multiplied by the square root of 52, an indication of volatility determined based on transactions occurring over a month can be multiplied by the square root of 12, an indication of volatility determined based on transactions occurring over a quarter can be multiplied by the square root of 4, and an indication of volatility determined based on transactions occurring over half a year can be multiplied by the square root of 2.

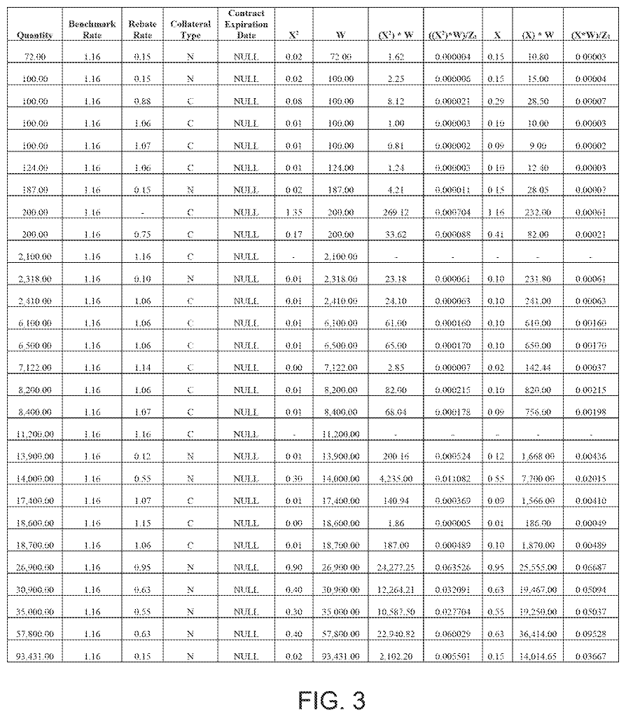

In FIG. 3, sample transaction data is shown for transactions occurring for a single security during a single day. In this example, Z₁, the sum of all the quantities of securities involved over all of the transactions for which data was acquired, is 382,164. The sum of ((X²)*W)/Z₁ is 0.203014 and the sum of (X*W)/Z₁ is 0.344274, which gives a value of 0.11852 when squared. This is subtracted from the sum of (X²)*W/Z₁ (or 0.023014) and the absolute value of the result is taken and then the square root, yielding a measure of securities lending volatility for that selected day of 0.29067 in this example, which translates to an annualized volatility of 4.68693 (or 0.29067 multiplied by the square root of 260 business days).

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1-3. (canceled)

4. A method for determining a measure of securities lending rate volatility comprising:
selecting a set of securities for which to determine the measure of securities lending rate volatility;
selecting a time period over which to determine the measure of securities lending rate volatility for the selected set of securities;
determining an intrinsic rebate rate for each of at least a plurality of open securities transactions occurring in the time period involving the selected set of securities;
determining a date of occurrence for each of the plurality of open securities transactions;
determining a time of occurrence for each of the plurality of open securities transactions;
determining a date of expiration for each of the plurality of open securities transactions;
determining a quantity of shares involved for each of the plurality of open securities transactions;
determining a sum of the quantity of shares involved for the plurality of open securities transactions;
determining a collateral type for each of the plurality of open securities transactions;
determining a benchmark interest rate in place at the time of occurrence for each of the plurality of open securities transactions; and
determining the measure of securities lending rate volatility for the time period for the selected set of securities based on at least the intrinsic rebate rate for each of the plurality of open securities transactions occurring in the time period involving the selected set of securities, the date of occurrence for each of the plurality of open securities transactions, the date of expiration of each of the plurality of open securities transactions, the quantity of shares involved in each of the plurality of open securities transactions, the sum of the quantity of shares involved for each of the plurality of open securities transactions, the collateral type for each of the plurality of open securities transactions, and the benchmark interest rate in place at the time of occurrence for each of the plurality of open securities transactions.

5. The method of claim 4, wherein the step of determining the measure of securities lending rate volatility is repeated based on updated data within five minutes.

6. A method for creating a securities lending rate volatility indicator comprising:
selecting a time period;
selecting at least one security;
receiving, for each of a plurality of securities lending transactions determined to have occurred in the selected time period and involving the selected security, a rebate rate, a date of transaction, an expiration date, and a quantity of shares involved; and
determining a measure of volatility, V, for the rebate rates for the plurality of securities lending transactions for the time period by applying a formula of
$$V = \sqrt{\vert ( {Σ}_{i = 1}^{n} ( \frac{( {X}_{i}^{2} ) * {W}_{i}}{{Z}_{1}} ) ) - {( {Σ}_{i = 1}^{n} ( \frac{( {X}_{i} ) * {W}_{i}}{{Z}_{1}} ) )}^{2} \vert}$$
where n is a quantity of transactions determined to have occurred in the selected time period,
where Z₁ is a sum of the quantity of shares involved in the plurality of securities lending transactions, and where X and W depend on a set of conditions, the set of conditions including:
((O=C)∧(∃R)∧((E≥D)∨( [symbol] E))∧(∃B)→X=(B−R)
((O=C)∧(∃R)∧((E≥D)∨( [symbol] E))∧(∃B)→W=(Q)
((O=L)∧(∃R)∧((E≥D)∨( [symbol] E))→X=(R)
((O=L)∧(∃R)∧((E≥D)∨( [symbol] E))→W=(Q)
where
O is a collateral type variable, the collateral type being for a one of the plurality of securities lending transactions,
C is the collateral type for a cash collateral transaction,
L is the collateral type for a non-cash collateral transaction,
E is the expiration for the one of the plurality of securities lending transactions,
D is a date of transaction for the one of the plurality of securities lending transactions,
B is a benchmark interest rate in place when the one of the plurality of securities lending transactions occurred, and
R is the rebate rate for the one of the plurality of securities lending transactions.

7. The method for creating a securities lending rate volatility indicator of claim 6 further including annualizing the measure of volatility by multiplying by the square root of the number of time periods in a year for the time period.

8. A system for determining a measure of volatility for rebate rates in securities lending, the system comprising:
a computer system including:
a data storage module for receiving securities lending transactional data for a plurality of transactions involving a selection of securities occurring within a selected time period, the transactional data including, for each of the plurality of transactions, whether cash or non-cash collateral was used, a date of transaction, an expiration date, a benchmark interest rate as of the date of transaction, a rebate rate, and a quantity of securities transacted; and
a processor configured to:
determine a measure of volatility of rebate rates for the selected securities for the selected time period by:
determining an intrinsic rebate rate for each of the plurality of transactions;
determining a date of occurrence for each of the plurality of transactions;
determining a time of occurrence for each of the plurality of transactions;
determining a date of expiration for each of the plurality of transactions;
determining a quantity of shares involved for each of the plurality of transactions;
determining a sum of the quantity of shares involved for the plurality of transactions;
determining a collateral type for each of the plurality of transactions;
determining a benchmark interest rate in place at the time of occurrence for each of the plurality of transactions; and
determining the measure of securities lending rate volatility for the time period for the selected set of securities based on at least the intrinsic rebate rate for each of the plurality of transactions occurring in the time period, the date of occurrence for each of the plurality of transactions, the date of expiration of each of the plurality of transactions, the quantity of shares involved in each of the plurality of transactions, the sum of the quantity of shares involved for each of the plurality of transactions, the collateral type for each of the plurality of transactions, and the benchmark interest rate in place at the time of occurrence for each of the plurality of transactions.

9. The system for determining a measure of volatility of claim 8, wherein the processor is further configured to annualize the measure of volatility.

10. The system for determining a measure of volatility of claim 8, wherein the measure of volatility is determined and disseminated in less than five minutes.
